(19) United States
(12) Patent Application Publication
(10) Pub. No.: US 2023/0018097 A1
(43) Pub. Date: Jan. 19, 2023

(54) SANDING PAD WITH FLEXIBLE AND DEFORMABLE CORE

(71) Applicant: John S. Conboy, Chesterfield, MO (US)

(72) Inventor: John S. Conboy, Chesterfield, MO (US)

(21) Appl. No.: 17/376,992

(22) Filed: Jul. 15, 2021

(51) Int. Cl. B24D 11/02; B24D 3/00

(52) U.S. Cl. CPC B24D 11/02; B24D 3/001

(57) ABSTRACT

A sanding pad comprises a laminate structure of a deformable and flexible core layer defining a first surface and an opposing second surface, each said surface having a sandpaper layer affixed thereto, whereby each said sandpaper layer is bonded to a plurality of fabric features, such as pile loops defining a respective one of the first and second core surfaces, whereby the pile loops defining the first core surface can flex in an opposite direction from the pile loops defining the second core surface when the core layer is deformed and flexed. In this regard, the core layer can flex in a variety of directions and conform to a variety of shapes and geometries, including convex and concave contours. The sandpaper layers each comprise an abrasive grit mounted to a backing layer which is bonded to the pile loops of the core layer.

### FIELD OF THE INVENTION

The present invention generally relates to sandpaper and sanding pads, and more particularly relates to a sanding pad with a flexible and deformable core layer provided to facilitate use of sandpaper in custom projects with curved, contoured and/or complex geometries.

### BACKGROUND OF THE INVENTION

Conventional sandpaper generally comprises abrasive material affixed to a flat or laminar backing material. In this regard, sandpaper is commonly provided in thin sheets that are adaptable for use by hand or mounted to a power-sander to smooth and finish a workpiece, typically made from wood, metal, fiberglass, plastic or the like. Sandpaper is used in a variety of applications, such as construction, carpentry, furniture-making and other woodworking tasks, automotive body production and repair, and boatmaking and repair. In each of these representative applications, sandpaper is generally needed to smooth and finish a variety of surface contours and geometries.

In the most basic use of sandpaper, a user holds the sheet of sandpaper in his or her hand and applies it to the workpiece to smooth and finish the surface of the workpiece. Owing to the flimsy nature of the sandpaper sheet, the sandpaper can easily fold, wrinkle or buckle, and ultimately tear during use especially with increased exertion of force and/or speed. As a result, users will often fold the sandpaper sheet to strengthen it during use. Similarly, a user will fold the sandpaper to fit into a tight space or conform to a specific shape or contour. However, even when the sheet of sandpaper is so folded, the sandpaper can easily be damaged during use, often along the crude folded line created by the user.

Power tools, such a power-sanders, are available that use precut sandpaper pieces mounted to a tool head for mechanical sanding. While such power sanders can facilitate and speed up the job, they are generally only good for sanding flat surfaces or rounded surfaces with large radii. Many custom jobs include detailed and complex geometries, contours and shapes that power sanders cannot conform to or fit into. As a result, power sanders are not suitable for most custom jobs. Similarly, sanding blocks or forms that grip a sheet of sandpaper are well-known for providing rigid support to the sandpaper during use, which can make a sanding job easier if a power sander is not available. For example, a common DIY approach to sanding is to affix a conventional sheet of sandpaper to a wood block that the user can more easily grip instead of trying to hold tight to a sheet of sandpaper. However, such rigid sanding blocks are also generally only good for flat surfaces and do not work well with curved or contoured surfaces. Additionally, the sandpaper tends to wear more quickly along the edges of such a rigid backing. Still further, if the sand paper has not been properly affixed to the block, it becomes more susceptible to wrinkling and buckling, and ultimately premature tearing.

Deformable sanding blocks are also available whereby the sanding block can be bent and shaped to a desired contour, providing an option for curved and contoured shapes. For example, some conventional deformable sanding blocks include an interior metal form that can be pre-shaped to a desired contour. Others utilize a deformable foam material. This can be advantageous provided the shape of the deformable sanding block adequately matches the shape of the workpiece. If there is a variance, then the sanding block is no different from a rigid sanding block. Moreover, as with rigid sanding blocks, such deformable sanding blocks require the user to attach the sandpaper to the block. If the sandpaper is not properly attached, it can easily wrinkle or buckle during use. If the sandpaper wrinkles or buckles, it can affect the use of the sandpaper and damage the workpiece. Additionally, such wrinkling and buckling can cause the sandpaper to tear. Additionally, if the sandpaper is attached to the block before it is deformed, then the sandpaper may wrinkle or buckle when the block is being shaped if the sandpaper sheet is attached too loosely, or tear or restrict deformation of the block if the sandpaper sheet is attached too tightly. Further, if the sandpaper sheet is attached to the block after it has been formed, then the tension of the sandpaper on the block will generally lock the shape of the block during use and restrict the block from being flexed during use. In effect, the deformable block in such a scenario has become a rigid sanding block only good for use with a specific contour. In many applications, the contour of the workpiece changes, and such a sanding block, even if deformable, cannot be used on varying contours without needing to remove the sandpaper, adjust the shape of the block, and then reapply the sandpaper, which adds time to the job.

Accordingly, using a sandpaper sheet by hand is often the best approach for curved and complex geometries, as the rigid alternatives of a power-sander and a sanding block generally cannot adequately conform to the shape of a workpiece or fit into tight concave or convex shapes of custom workpieces such as molding, furniture legs and detail, balusters and posts for banisters or railings, or the like.

In view of the foregoing, there is a need for a sanding pad that can be used for custom projects involving curved and complex geometries, including workpieces with concave, convex or other intricate surfaces needing sanding. Additionally, there is a need for a sanding pad with adequate flexibility for use in custom projects with curved or complex geometries where the sanding pad can be flexed and deformed to complement the shape of the workpiece with the surface of the outer sandpaper layer remaining uniform so as to facilitate the sanding task at hand. More preferably, there is a need for a sanding pad with an adequate balance of flexibility and rigidity so that the sanding pad can be deformed to a desired shape while maintaining a level of stiffness so as to avoid folding, buckling or tearing that will affect use of the sanding pad, and further allow for deformation during use to complement and accommodate varying contours and geometries. Still further, there is a need for a flexible and deformable sanding pad with some elasticity so that the sanding pad can adapt during use while also being reusable for multiple projects with a variety of contoured workpieces. Accordingly, an aspect of the present invention is to provide a sanding pad with a flexible and deformable core layer that improves upon conventional sandpaper sheets and supports currently on the market and that overcomes the problems and drawbacks associated with such prior art sandpaper and sanding products.

### SUMMARY OF THE INVENTION

In accordance with the present invention, a sanding pad adaptable for custom projects with curved, contoured or complex geometries is provided. Notably, the sanding pad can be flexed and deformed to conform and complement the shape and geometry of a workpiece without damaging the sandpaper layer or the workpiece. The sanding pad of the present invention is especially adaptable to conform to the shape of a workpiece or fit into tight concave or convex shapes of custom workpieces such as molding, furniture legs and detail, balusters and posts for banisters or railings, automotive bodies or parts, boat hulls or parts, or the like.

In general, a sanding pad in accordance with the present invention comprises a flexible and deformable core layer with at least one sandpaper layer affixed thereto. In preferred embodiments, the core layer comprises a woven terry cloth construction, more preferably a three-pick terry weave, including a first plurality of multi-directionally and independently flexible fabric features, generally in the form of pile loops, defining a first surface to which a first sandpaper layer is attached and a second plurality of multi-directionally and independently flexible fabric features, also generally in the form of pile loops, defining an opposing second surface to which a second sandpaper layer is attached. The sandpaper layers each comprise an abrasive grit mounted to a backing layer which is bonded to the pile loops of the core layer. In use, the sanding pad can flex and deform to a desired shape without the sandpaper layer(s) folding, wrinkling, buckling or tearing. More particularly, the pile loops are independently deformable and multi-directionally flexible such that loops can flex in different and opposite directions as needed during flexing and deformation of the sanding pad. Advantageously, the sandpaper layer of the sanding pad can be flexed to concave and convex shapes alike without folding, wrinkling, buckling or tearing.

In embodiments of the present invention, the core layer comprises a plurality of pile loops defining at least a first surface to which a first sandpaper layer is affixed. In this regard, the core layer comprises a woven terry cloth construction, and more particularly, may comprise a two-pick terry weave. More preferably, the core layer comprises a three-pick terry weave that includes pile loops on both side surfaces of the core layer, with sandpaper layers attached on each of the side surfaces.

In an alternate embodiment of the present invention, the core layer comprises a non-woven construction including a plurality of multi-directionally and independently flexible fabric features, generally comprising bonded filaments, defining a first surface to which a first sandpaper layer is attached and an opposing second surface to which a second sandpaper layer is attached. The non-woven core layer can comprise a felting or a needle-punched wadding material wherein the filaments are matted, felted, adhered or fused together to define the non-woven layer, yet the individual filaments remain independent and can flex in multiple directions. In embodiments, the filaments can be different durometers and lengths in order to achieve desired flexibility and rigidity for use.

In an aspect of the present invention, the core layer is constructed from a cotton weave, or a combination of cotton and spandex. The relative percentages of cotton and spandex can be adjusted to adjust the rigidity and/or elasticity of the core layer. For example, in embodiments of the present invention, a “soft” construction of the sanding pad may comprise a central core layer of about 100% cotton construction, while a “medium” construction of the sanding pad may comprise a central core layer made from a blend of about 80% cotton and about 20% spandex. Alternate materials that can be used include, but are not limited to bamboo fibers, silk, polyester, corn, plastic or cotton/poly blends.

As noted, preferred embodiments include sandpaper layers provide on each side surface of the core layer. More particularly, the first and second sandpaper layers are bonded to the respective pile loops defining each of the first and second surfaces of the core layer. The sandpaper layers each comprise an abrasive grit mounted to a backing layer. In accordance with the present invention, the coarseness of the abrasive grit for each of the first and second sandpaper layers can be different to increase utility of the sanding pad.

Still further, each sandpaper layer may comprise a laminate to improve the wet strength of each said layer so that the sandpaper layers will hold their shape, even when flexed or curved and not crack when bent or flexed.

In an aspect of the present invention, the sandpaper layer is bonded to the pile loops of the core layer using a glue or adhesive.

In another aspect of the present invention, the edges of the core layer can be sealed to keep the fiber features from falling or pulling out from the sanding pad. For example, the edges can be coated using a glue or an elastomeric coating material. Still further, the edges can be sealed or cauterized through the manufacturing process, such as by cutting the materials with a laser or hot knife.

In accordance with the present invention, the flexibility and rigidity of the sanding pad can be varied in construction. For example, sanding pads can be produced with varying levels of rigidly, such as soft, medium or firm. The rigidity can be varied through changes in at least one of the thickness of the core layer, the material of the core layer, the number of pile loops on each surface of the core layer, the lengths of the pile loops, the thickness and/or stiffness of the backing layer for the sandpaper layer(s), and combinations thereof.

In use, the sanding pad of the present invention can conform to the shape of the workpiece without the sandpaper layer(s) folding, wrinkling of buckling. The pile loops of the core layer independently flex, bend and compress to allow the shape of the sanding pad to adjust to a desired contour and curvature, generally complementing the geometry of the workpiece, including permitting deformation during use as the geometry of the workpiece may change. The flexibility and built in elasticity of the core layer will allow the sanding pad to return to a rest condition when not in use. As a result, the sanding pad, once deformed, is not restricted to a certain shape or deformation, and can be used with a variety of shape, contours and geometries.

In another aspect of the present invention, a sanding pad comprises a laminate structure of a deformable and flexible core layer defining a first surface and an opposing second surface, each said surface having a sandpaper layer affixed thereto, whereby each said sandpaper layer is bonded to a plurality of pile loops defining a respective one of the first and second core surfaces, whereby the pile loops defining the first core surface can flex in an opposite direction from the pile loops defining the second core surface when the core layer is deformed and flexed. In this regard, the core layer can flex in a variety of directions and conform to a variety of shapes, including convex and concave contours.

These and other objects, features and advantages of the present invention will become apparent in light of the detailed description of embodiments thereof, as illustrated in the accompanying drawings. The illustrated embodiments of features of the present invention are intended to illustrate, but not limit the invention.

### BRIEF DESCRIPTION OF THE DRAWINGS

FIG. 1 illustrates a perspective view of an embodiment of a sanding pad in accordance with the present invention.

FIG. 2 illustrates a cross-sectional view of the sanding pad of FIG. 1.

FIG. 3 illustrates a close-up cross-sectional view of the sanding pad of FIG. 1.

FIG. 4 illustrates a perspective view of the sanding pad of FIG. 1 in a first deformed condition.

FIG. 5 illustrates a cross-sectional view of the deformed sanding pad of FIG. 4.

FIG. 6 illustrates a close-up cross-sectional view of the deformed sanding pad of FIG. 4.

FIG. 7 illustrates a close-up cross-sectional view of an alternate embodiment of a sanding pad in accordance with the present invention.

FIG. 8 illustrates a close-up cross-sectional view of another alternate embodiment of a sanding pad in accordance with the present invention.

### DETAILED DESCRIPTION OF EMBODIMENTS OF THE INVENTION

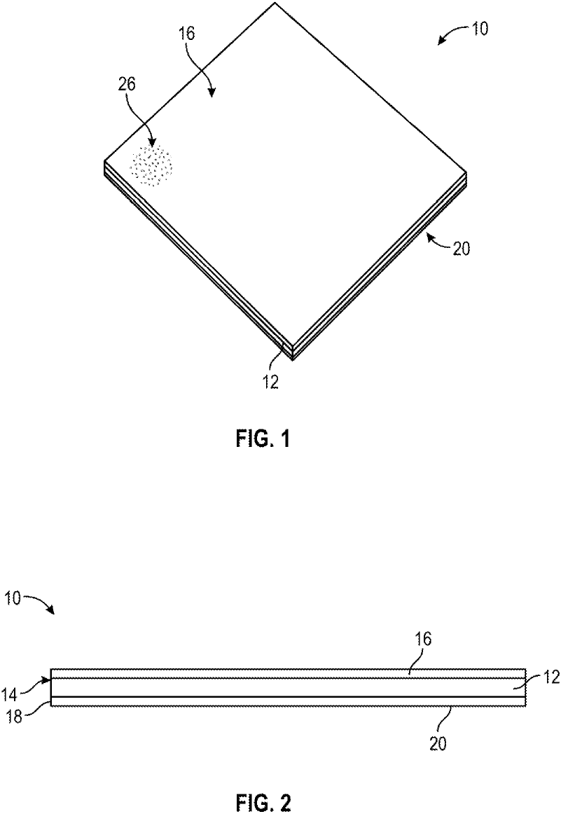

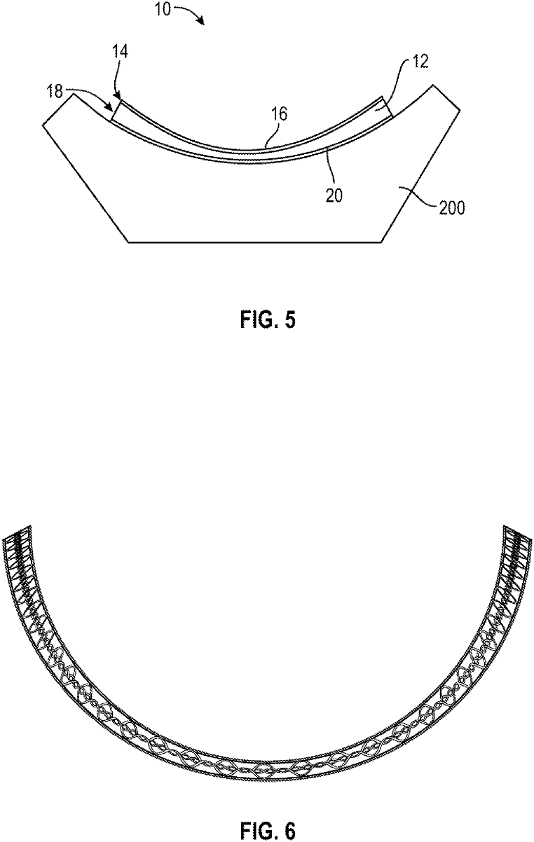

In the drawings and the description that follows, the present invention is illustrated and described with reference to sanding pad designs embodying the present invention. More particularly, a sanding pad with a flexible and deformable core layer and at least one outer sandpaper layer in accordance with the present invention is illustrated in FIGS. 1-6. In FIG. 1, a sanding pad, generally designated by reference numeral 10, is shown in a relaxed condition. By comparison, FIG. 4 shows the sanding pad 10 in a flexed condition adapted for use in sanding a workpiece having a contoured geometry to which the sanding pad 10 can be shaped and conformed by flexing and deforming the pad 10. FIG. 5 illustrates the sanding pad 10 conforming to the curved shape of a workpiece 200. The flexed condition illustrated in FIG. 4 is just one option for deforming the sanding pad 10 provide for illustration. Notably, the sanding pad 10 can be flexed in multiple directions such that either side of the sanding pad 10 can be used on a workpiece.

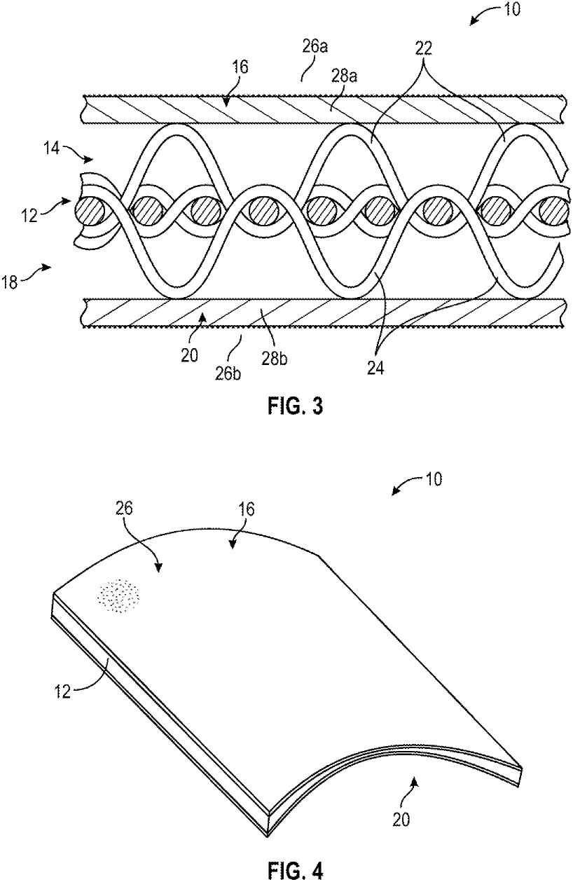

Referring to FIG. 2, the sanding pad 10 generally comprises a laminate structure having an inner core layer 12 defining a first surface 14 to which a first sandpaper layer 16 is affixed and a second opposing surface 18 to which a second sandpaper layer 20 is affixed. In preferred embodiments, the core layer 12 comprises a woven terry cloth construction, more preferably a three-pick terry weave, though alternative pick constructions, such as a four-pick and five-pick, may be used without departing from the principles and spirit of the present invention. Referring more closely to FIG. 3, the core layer 12 comprises a first plurality of multi-directionally and independently flexible fabric features, generally in the form of pile loops 22 defining the first surface 14 and a second plurality of multi-directionally and independently flexible fabric features, also generally in the form of pile loops 24 defining the second surface 18. Each of the sandpaper layers 16 and 20 are bonded to the pile loops 22 and 24.

The sandpaper layers 16 and 20 each comprise an abrasive grit 26a and 26b, respectively, mounted to a backing layer 28a and 28b, such as paper, cardstock, or similar materials providing a stiffness to the sandpaper layers 16 and 20. The abrasive grit 26 provides a coarseness to the sandpaper layers, as is well known in the art. As noted, the first sandpaper layer 16 is affixed to the first surface 14 of the core layer 12 and the second sandpaper layer 20 is affixed to the second surface 18. More particularly, as shown in FIG. 3, the first and second sandpaper layers 16 and 20 are bonded to the respective pile loops 22 and 24 defining each of the first and second surfaces 14 and 18 of the core layer 12. In accordance with the present invention, the sandpaper layers 16 and 20 are bonded to the pile loops 22 and 24 of the core layer 12 using a glue or adhesive.

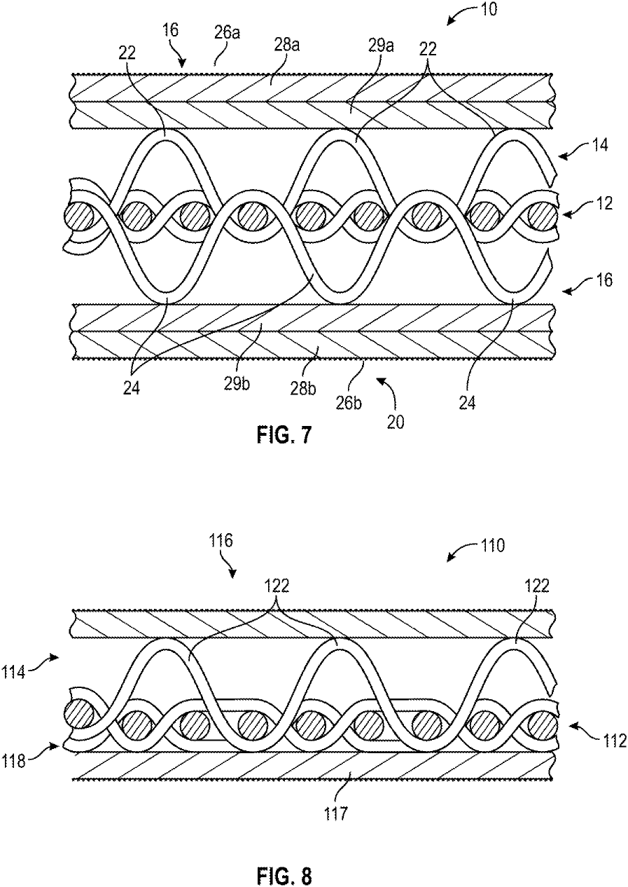

In accordance with the present invention, each sandpaper layer may comprise a laminate to improve the wet strength of each said layer so that the sandpaper layers will hold their shape, even when flexed or curved and not crack when bent or flexed. For example, as illustrated in FIG. 7, the sandpaper layers 16 and 20 can comprises a first layer formed from the abrasive grit 26a and 26b respectively mounted to a backing layer 28a and 28b. The first layer can be bonded to a respective second layer 29a and 29b, generally comprising paper, cardstock, or similar materials providing a stiffness to the sandpaper layers 16 and 20 without compromising the flexibility of each said layer. Additional layers can be added to increase the thickness and rigidity as desired.

As so attached, the flexibility of the pile loops 22 and 24 facilitates flexing and movement of the sandpaper layers 16 and 20 without damage. For example, when bending the sanding pad 10, as illustrated in FIG. 4, the sandpaper layer on the concave side (illustrated as layer 16 in FIGS. 4-5) won’t buckle or fold because the pile loops 22 on that side of the core layer 12 will compress and/or layer with flexing of the core layer 12. Indeed, as see in FIGS. 5-6, the portion of the core layer 12 near the center of the sanding pad 10 is compressed in thickness more than the portions of the core layer 12 at the extremes. Likewise, the sandpaper layer on the convex side (illustrated as layer 20 in FIGS. 4-5) won’t tear or restrict flexing of the sanding pad 10 because the pile loops 24 on that side of the core layer 12 will spread, stretch and/or layer, usually in different directions from the pile loops 22 on the other side of the core layer 12, to allow the sandpaper layer to accommodate the flexing of the pad 10. In use, the pad 10 can quickly be inverted to shift one sandpaper layer from concave to convex and the other sandpaper layer from convex to concave - for example, to change between sandpaper layers especially if they are of different abrasive coarseness - without damaging the sandpaper layers. In use, both sandpaper layers 16 and 20 remain uniform - i.e., without creases, bumps, or tears -regardless of how they are flexed and deformed.

Still further, when the sanding pad 10 is flexed, such as illustrated in FIGS. 4-5, the core layer 20 compresses in the center portion near the bend of the sanding pad 10 so that the thickness of the core layer 20 is thinner than when at rest (as in FIGS. 1-2). At the same time, the core layer 20 out the edges of the sanding pad 10 expand, as illustrated, so that the thickness of the core layer 20 is thicker than when at rest. In this regard, the pile loops 22 and 24 are adapted to contract or expand in addition to being able to move multi-directionally with the flexing of the sanding pad 10 to a desired configuration, shape and curvature.

In accordance with the present invention, the coarseness of the abrasive grit for each of the first and second sandpaper layers 16 and 20 can be different to increase the utility of the sanding pad 10. For example, one side can have a fine sandpaper grit while the other side is more coarse.

In alternate embodiments, a sanding pad 110 in accordance with the present invention can comprise a laminate with a core layer 112 and just one sandpaper layer 116, as illustrated in FIG. 8. In this regard, the core layer 112 comprises a plurality of pile loops 122 defining a first surface 114 to which just a first sandpaper layer 116 is affixed. For this construction, the core layer 112 may comprise a woven terry cloth construction, and more particularly, may comprise a two-pick terry weave without departing from the principles and spirit of the present invention. The opposing second surface 118 of the core layer 112 can be exposed, or include a solid backing paper 117 (as illustrated), or even a grip or handle to facilitate holding the sanding pad 110.

In another alternate embodiment of the present invention, the sanding pad can be constructed using a core layer that comprises a non-woven construction including a plurality of multi-directionally and independently flexible fabric features, generally comprising bonded filaments, defining a first surface to which a first sandpaper layer is attached and an opposing second surface to which a second sandpaper layer is attached. The non-woven core layer can comprise a felting or a needle-punched wadding material wherein the filaments are matted, felted, adhered or fused together to define the non-woven layer, yet the individual filaments remain independent and can flex in multiple directions. Such non-woven layers are often used for quitting, stuffing, batting or wadding, and generally comprise layers or sheets of raw cotton, wool or synthetic materials. In embodiments, the filaments can be different durometers and lengths in order to achieve desired flexibility and rigidity for use.

In embodiments of the present invention, the core layer is constructed from a cotton weave, or a combination of cotton and spandex. Preferably the materials are conducive to imparting the sanding pad 10 with an adequate balance of flexibility and rigidity. Still further, the materials preferably provide the core layer 12 with elasticity such that the sanding pad 10 can be flexed and deformed to various shapes and contours, unlike many prior art sanding blocks which are essentially locked into a particular shape and thus not useful for workpieces with varying contours. In this regard, the sanding pad 10 is reusable for the reasonable life of the sandpaper layers.

The relative percentages of cotton and spandex can be adjusted to adjust the rigidity and/or elasticity of the core layer 12. For example, in embodiments of the present invention, a “soft” construction of the sanding pad may comprise a central core layer of about 100% cotton construction, while a “medium” construction of the sanding pad may comprise a central core layer made from a blend of about 80% cotton and about 20% spandex. Alternate materials that can be used include, but are not limited to bamboo fibers, silk, polyester, corn, plastic or cotton/poly blends. To adjust the softness or firmness of the sanding pad, the pile loops can be made from a different fiber than the warp and weft fibers of the terry weave. For example, increasing the spandex concentration of the loops will impart greater capacity for compression and stretching, and thus make the central core layer more flexible and compliant. Additionally, adjusting the thickness of the core layer will also adjust the softness or firmness, often in combination with the length of the loops. Still further, adjustments to the laminate sandpaper layers can increase or decrease the rigidity of the sandpaper pad, as discussed below.

In accordance with the present invention, the flexibility and rigidity of the sanding pad 10 can be varied in construction. For example, sanding pads can be produced with varying levels of rigidly, such as soft, medium or firm. Softer pads are more flexible and preferred for workpieces with smaller and more intricate detail, more contoured shapes, curvatures with smaller radii, and more variance in contours. Firmer pads are more rigid, but perhaps more elastic, and preferred for repetitive use on common contours and geometries - e.g., production line construction of furniture parts, automotive parts, boats, and the like. The rigidity can be varied through changes in at least one of the thickness of the core layer, the material of the core layer, the number of pile loops on each surface of the core layer, the lengths of the pile loops, the thickness and/or stiffness of the backing layer for the sandpaper layer(s), and combinations thereof. For example, for a firmer sanding pad, the core layer can be made thicker, use a more intricate terry weave such as a four- or five-pick weave, use stiffer thread materials in the weave, increase the percentage of a stiffer material (such as spandex) relative to cotton, increase the number of pile loops and shorten the length of the loops, and increase the thickness and stiffness of the backing payer for the sandpaper layers. By comparison, a softer sanding pad would use a thinner core layer with a higher percentage of cotton or similar low rigidity, low elasticity material, a reduce number of pile loops with longer length, and a thinner, more flexible backing layer on each of the sandpaper layers.

The rigidity of the sandpaper pad can also be adjusted by adjusting the thickness and stiffness of the outer sandpaper layers. For example, the range of thickness of each of the sandpaper layers in preferred embodiments can be between about 0.005 in to 0.01 in. Additional laminate layers can be added to adjust the rigidity of the outer sandpaper layers as well.

Preferably sanding pads in accordance with the present invention are provided in square laminar pads of about 3 in. x 3 in., 3.5 in. x 3.5 in., or 4 in. x 4 in. sizes. In the alternative, the pads can be made of circular, oval, rectangular or triangular shape without departing from the principles and spirit of the present invention.

Preferably, the flexibility and rigidity of the sanding pad is balanced to provide a bend to a ½ inch radius. As noted, features of the sanding pad are variable so that the softness and firmness of the pad can be adjusted in construction to provide a variety of pads adaptable to various uses, workpiece geometries, and workpiece materials.

In another aspect of the present invention, the edges of the core layer can be sealed to keep the fiber features from falling or pulling out from the sanding pad. For example, the edges can be coated using a glue or an elastomeric coating material. Still further, the edges can be sealed or cauterized through the manufacturing process, such as by cutting the materials with a laser or hot knife.

The use of a core layer comprising a plurality of fabric features that are multi-directioiially and independently flexible, whether such fabric features comprise pile loops in a woven fabric or bonded filaments in a non-woven layer, have proven more effective for sandpaper construction than foam layers. Foam layers tend to wrinkle when bent of folded, which affects the outer sandpaper layer. As noted, wrinkling or tearing of the sandpaper layer affects usage, especially for custom projects. By comparison, the use of fabric features that can be flexed independently in different, and even random, directions when flexing the sandpaper pad allows the entire sandpaper pad to be flexed and bent as needed without the sandpaper layers being wrinkled or torn.

The foregoing description of embodiments of the invention has been presented for the purpose of illustration and description. It is not intended to be exhaustive of to limit the invention to the form disclosed. The embodiments described were chosen to best illustrate the principles of the invention and practical applications thereof to enable one of ordinary skill in the art to utilize the invention in various embodiments and with various modifications as suited to the particular uses contemplated. It should be appreciated by those of ordinary skill in the art that various modifications to the invention may be made without departing from the spirit and scope of the invention.

What is claimed is:

1. A sanding pad comprising:
a flexible and deformable core layer having a woven terry cloth construction including a first plurality of pile loops defining a first surface and a second plurality of pile loops defining an opposing second surface;
a first sandpaper layer attached to the first surface of the core layer; and
a second sandpaper layer attached to the second surface of the core layer,
wherein each of the first and second sandpaper layers comprises an abrasive grit mounted to a backing layer.

2. The sanding pad according to claim 1, wherein the core layer comprises a three-pick terry weave.

3. The sanding pad according to claim 2, wherein the core layer is constructed from about 100% cotton material.

4. The sanding pad according to claim 2, wherein the core layer is constructed from a material blend of about 80% cotton and about 20% spandex.

5. The sanding pad according to claim 1, wherein the backing layer of each of the first and second sandpaper layers is bonded to a respective plurality of pile loops of the core layer.

6. The sanding pad according to claim 5, wherein each of the first and second sandpaper layers is bonded to the respective plurality of pile loops of the core layer using a glue or adhesive.

7. The sanding pad according to claim 1, wherein the abrasive grit for each of the first and second sandpaper layers has a coarseness, wherein the coarseness of the abrasive grit for the first sandpaper layer differs from the coarseness of the abrasive grit for the second sandpaper layer.

8. A sanding pad comprising:
a flexible and deformable core layer having a woven terry cloth construction including a first plurality of pile loops defining a first surface;
a first sandpaper layer attached to the first surface of the core layer, said sandpaper layer comprising an abrasive grit mounted to a backing layer.

9. The sanding pad according to claim 8, wherein the core layer comprises a two-pick terry weave.

10. The sanding pad according to claim 9, wherein the core layer is constructed from about 100% cotton material.

11. The sanding pad according to claim 9, wherein the core layer is constructed from a material blend of about 80% cotton and about 20% spandex.

12. The sanding pad according to claim 8, wherein the core layer comprises a three-pick terry weave.

13. The sanding pad according to claim 8, wherein the backing layer of the first sandpaper layer is bonded to the first plurality of pile loops of the core layer.

14. The sanding pad according to claim 13, wherein the first sandpaper layer is bonded to the first plurality of pile loops of the core layer using a glue or adhesive.

15. A sanding pad comprising:
a laminate structure of a deformable and flexible core layer defining a first surface and an opposing second surface, each said surface having a sandpaper layer affixed thereto,
whereby each said sandpaper layer is bonded to a plurality of pile loops defining a respective one of the first and second core surfaces,
whereby the pile loops defining the first core surface can flex in an opposite direction from the pile loops defining the second core surface when the core layer is deformed and flexed.

16. The sanding pad according to claim 15, wherein the core layer comprises a three-pick terry weave.

17. The sanding pad according to claim 16, wherein the core layer is constructed from about 100% cotton material.

18. The sanding pad according to claim 16, wherein the core layer is constructed from a material blend of about 80% cotton and about 20% spandex.

19. The sanding pad according to claim 1, wherein the backing layer of each of the first and second sandpaper layers is bonded to a respective plurality of pile loops of the core layer.

20. The sanding pad according to claim 5, wherein each of the first and second sandpaper layers is bonded to the respective plurality of pile loops of the core layer using a glue or adhesive.
